(19) United States
(12) Patent Application Publication
(10) Pub. No.: US 2007/0272508 A1
(43) Pub. Date: Nov. 29, 2007

(54) WET MULTI-PLATE CLUTCH OF MECHANICAL COUPLING TYPE

(76) Inventors: Ritsuo Toya, Fukuroi-shi (JP); Manabu Sawayanagi, Fukuroi-shi (JP); Shigeharu Nishimura, Fukuroi-shi (JP)

Correspondence Address: MILES & STOCKBRIDGE PC, 1751 PINNACLE DRIVE, SUITE 500, MCLEAN, VA, 22102-3833, US

(21) Appl. No.: 11/754,961

(22) Filed: May 29, 2007

(30) Foreign Application Priority Data
May 29, 2006 (JP) 2006-148282

(51) Int. Cl. F16D 47/00

(52) U.S. Cl. 192/48.3

(57) ABSTRACT

The present invention provides a wet multi-plate clutch of mechanical coupling type in which friction engaging elements and mechanical coupling elements are operated by a single piston and wherein the friction engaging elements are operated by an urging force of the single piston smaller than a predetermined load, and the friction engaging elements and mechanical coupling elements are operated by an urging force of the single piston greater than the predetermined load.

### BACKGROUND OF THE INVENTION

1. Field of the Invention

The present invention relates to a wet multi-plate clutch of mechanical coupling type which can be used as a transmission clutch of an automatic transmission, a lock-up clutch, a starting clutch, a 4-wheel driving clutch or the like of a vehicle.

2. Description of the Related Art

Wet multi-plates clutches comprising paper friction materials have advantages that transmitted torque can be controlled by loads acting on friction surfaces of the friction materials and that smooth engagement can be achieved during the transmission of the torque and, thus, have been mainly used widely as transmitting mechanisms of automatic transmissions, torque converters, starting clutches, 4-wheel driving differentials. An example of such wet multi-plate clutch is disclosed in Japanese Patent Application Laid-open No. 2004-251372.

However, in recent years, in order to meet requirements regarding reduction in consumption of fuel and reduction in cost, it has been requested that the number of plates in the wet multi-plate clutch be reduced and an installation space be reduced and a pump capacity be made more compact. In order to permit the wet multi-plate clutch to transmit the required torque, it is necessary to provide a predetermined urging force and the predetermined number of plates, and, thus, it was difficult to reduce the number of plate and to reduce the installation space.

### SUMMARY OF THE INVENTION

An object of the present invention is to provide a wet multi-plate clutch of mechanical coupling type in which, while taking advantage of benefit of a multi-plate clutch including wet friction materials, i.e. taking advantage of the characteristic which can control transmitted torque by an urging force, smooth engagement can be realized by friction engaging elements upon initiation of the engagement and required great torque can be transmitted by machine coupling elements during the complete engagement, with urging forces of a single piston.

To achieve the above object, the present invention provides a wet multi-plate clutch of mechanical coupling type in which friction engaging elements and mechanical coupling elements are operated by a single piston and wherein the friction engaging elements are operated by an urging force of the single piston smaller than a predetermined load, and the friction engaging elements and mechanical coupling elements are operated by an urging force of the single piston greater than the predetermined load.

According to the present invention, the following advantages can be obtained.

Since smooth engagement can be realized by the friction engaging elements upon initiation of the engagement and required great torque can be transmitted by the mechanical coupling elements during the complete engagement, with urging forces of the single piston, control of transmission of the torque can be facilitated.

When the clutch is used as a starting clutch or a lock-up clutch of a torque converter, in a small zone of the transmitted torque, slip control of the wet multi-plate clutch can be performed, and the great torque can be transmitted via the mechanical coupling during the complete engagement.

Further, when the clutch is used as a switching clutch for switching between a 2-wheel drive mode and a 4-wheel drive mode of a 4-wheel drive vehicle, the transmitted torque of front wheels and rear wheels can be distributed by the wet multi-plate clutch, and greater torque can be transmitted via the mechanical coupling during the complete engagement. In this case, by using a clutch of mechanical coupling type having a one-way clutch function in a front wheel drive portion, during the 4-wheel driving, when the vehicle is turned, a rotational difference between the front wheels and the rear wheels can be absorbed. In this case, the wet multi-plate clutch is engaged; and, by controlling an engaging force of the wet multi-plate clutch, enhancement of more stable turn performance can be expected. Further, during a rearward running, even when the one-way clutch is used, the torque can be transmitted by the wet multi-plate clutch alone.

Further features of the present invention will become apparent from the following description of exemplary embodiments with reference to the attached drawings.

### BRIEF DESCRIPTION OF THE DRAWINGS

FIG. 1 is an axial partial sectional view of a wet multi-plate clutch of mechanical coupling type according to the present invention.

FIG. 2 is a front view, in partial fragmental, of the clutch shown in FIG. 1, with a condition that the clutch is not locked.

FIG. 3 is a front view, in partial fragmental, of the clutch shown in FIG. 1, with a condition that the clutch is locked in a clockwise direction.

FIG. 4 is a front view, in partial fragmental, of the clutch shown in FIG. 1, with a condition that the clutch is locked in an anti-clockwise direction.

FIG. 5 is a front view, in partial fragmental, of the clutch shown in FIG. 1, with a condition that the clutch is locked in a clockwise direction.

### DESCRIPTION OF THE EMBODIMENTS

Now, the present invention will be fully explained with reference to the accompanying drawings. Incidentally, it should be noted that an embodiment which will be described hereinafter is merely an example of the present invention and does not limit the present invention. Further, in the drawings, the same elements are designated by the same reference numerals.

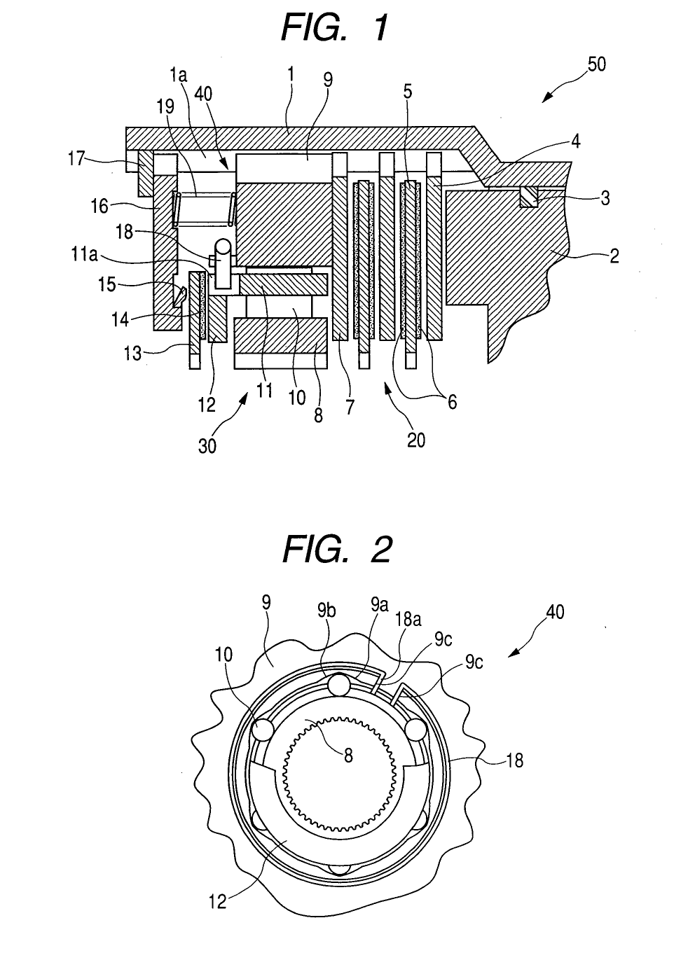

FIG. 1 is an axial partial sectional view of a wet multi-plate clutch of mechanical coupling type according to the present invention. The wet multi-plate clutch of mechanical coupling type 50 includes a friction engaging element portion 20 comprising a plurality of friction engaging elements and disposed adjacent to a piston 2, and a mechanical coupling element portion 30 comprising a plurality of mechanical coupling elements.

The wet multi-plate clutch of mechanical coupling type 50 further includes a substantially cylindrical drum or clutch case 1 having one axial open end, a hub (not shown) mounted within the clutch case 1 in coaxial with the clutch case for a relative rotation, annular external toothed plates or separator plates 4 mounted to a spline member la provided on an inner periphery of the clutch case 1 for an axial sliding movement, and annular internal toothed plates or friction plates 5 which are mounted to a spline member (not shown) provided on an outer periphery of the hub and which are arranged alternately with the separator plates 4 along an axial direction and to which friction materials 6 are stuck. Plural separator plates 4 and plural friction plates 5 are provided. The separator plates 4 and the friction plates 5 constitute the friction engaging element portion 20.

The wet multi-plate clutch of mechanical coupling type 50 further includes a piston 2 for urging the separator plates 4 and the friction plates 5 to engage these plates with each other. Within the open end portion of the clutch case 1, there are provided a backing plate 16 provided on the inner periphery of the clutch case 1, and a stop ring 17 for holding the backing plate.

As shown in FIG. 1, the single piston 2 is mounted within the closed end portion of the clutch case 1 for an axial sliding movement. A piston seal ring 3 such as an O-ring is disposed between an outer peripheral surface of the piston 2 and the inner peripheral surface of the clutch case 1, and an oil-tight hydraulic pressure chamber (not shown) is defined between an inner surface of the closed end portion of the clutch case 1 and the piston 2. By ON/OFF of hydraulic pressure in the hydraulic pressure chamber, the wet multi-plate clutch of mechanical coupling type 50 can be engaged (tightened) and disengaged (released).

The friction plates 5 each held for an axial sliding movement has both surfaces to which friction materials 6 having predetermined coefficient of friction are secured. However, the friction material 6 may be provided on only one surface of the friction plate 5 and of the separator plate 4.

The mechanical coupling element portion 30 is disposed adjacent to the friction engaging element portion 20 in the axial direction. A load controlling plate 7 is disposed between the friction engaging element portion 20 and the mechanical coupling element portion 30. The annular load controlling plate 7 is mounted to the spline member la of the clutch case 1 for an axial shifting movement.

The mechanical coupling element portion 30 comprises a two-way clutch or a one-way clutch 40. In FIG. 1, such a clutch is generically referred to merely as “clutch”. The clutch 40 comprises an outer race 9, an inner race 8 mounted within the outer race 9 and in coaxial with the outer race for a relative rotation, rollers 10 disposed between the outer race 9 and the inner race 8 to transmit torque between the outer and inner races, and a holder 11 for holding the rollers 10.

An axial one end of the outer race 9 of the clutch 40 abuts against the load regulating plate 7 and the other end is contacted with a load regulating spring 19 disposed between the backing plate 16 and the outer race 9. That is to say, the outer race 9 is urged against the load regulating plate 7 by the load regulating spring 19 with a predetermined biasing force. The load regulating spring 19 can optionally be selected from a coil spring, a coned disc spring or the like.

The holder 11 of the clutch 40 has a substantially annular shape and is provided at its one axial end with a holder friction plate 12 formed as a flange integrally provided therewith. Further, in the vicinity of the holder friction plate 12, there is provided a holder biasing spring 18 for holding the holder 11 in a neutral position of the rollers 10. Here, the holder biasing spring 18 is a C-shaped spring and, as will be described later with reference to FIG. 2, bent portions of the spring are fitted into notch portions provided in end faces of the outer race 9 and the holder 11.

A holder controlling plate 13 is provided in a confronting relationship to the holder friction plate 12. In the holder controlling plate 13 an inner portion of which is engaged through spline with the hub, a friction material 14 is stuck to a surface of the plate opposed to the holder friction plate 12. The holder controlling plate 13 is biased toward the holder friction plate 12 by a control spring 15 provided on the backing plate 16 and adapted to control a friction force of the holder 11.

When the wet multi-plate clutch of mechanical coupling type 50 is in an inoperative condition, the holder controlling plate 13 does not abut against the holder friction plate 12. When the wet multi-plate clutch of mechanical coupling type 50 is operated to displace the holder 11 of the clutch 40 to the left (FIG. 1), the holder friction plate 12 abuts against the holder controlling plate 13, with the result that these plates are frictionally coupled to each other via the friction material 14. In this case, an abutment condition between the holder friction plate 12 and the holder controlling plate 13 is controlled by a biasing force of the control spring 15. Incidentally, the control spring 15 can optionally be selected from a coil spring, a coned disc spring or the like.

The wet multi-plate clutch of mechanical coupling type 50 having the above-mentioned construction is operated as follows. When the hydraulic pressure is supplied to the hydraulic pressure chamber (not shown) to shift the piston 2 to the left (FIG. 1), first of all, the piston abuts against the right-most separator plate 4. When the piston 2 is further shifted, the separator plates 4 and the friction plates 5 are engaged with each other, thereby achieving an engagement (tightened) condition of the friction engaging element portion 20. In this condition, although the left-most friction plate 5 abuts against the load controlling plate 7, the piston 2 does not generate any urging force until the movement of the outer race causes the load controlling plate 7 to shift the holder 11 in the axial direction.

When an urging force smaller than a predetermined load previously set is applied to the friction engaging element portion 20 by the piston 2, the friction engaging element portion 20 is operated and tightened as mentioned above, and, when an urging force greater than the predetermined load is applied by the piston 2, not only the friction engaging element portion 20 but also the mechanical coupling element portion 30 are operated. That is to say, the friction engaging and the mechanical coupling are performed simultaneously.

When the urging force of the piston 2 is transmitted to the mechanical coupling element portion 30 in this way, the outer race 9, holder 11 and inner race 8 as the main elements of the mechanical coupling element portion 30 are urged via the load controlling plate 7. In this case, the outer race 9 is shifted to the left (FIG. 1) in opposition to the biasing force of the load regulating spring 19.

When the holder 11 is urged by the load controlling plate 7, the holder controlling plate 13 fitted into the spline member (not shown) provided on the outer periphery of the hub is frictionally engaged with the holder friction plate 12. As a result, the holder 11 is driven toward an engaging direction by the friction force from the holder controlling plate 13.

As mentioned above, according to the wet multi-plate clutch of mechanical coupling type 50 of the present invention, two-stage torque transmission can be performed. That is to say, since, by the urging forces of the single piston 2, the smooth engagement can be realized by the friction engaging elements 20 upon initiation of the engagement and the required great torque can be transmitted by the mechanical coupling elements including the two-way clutch or the one-way clutch during the complete engagement, the control of transmission of the torque can be facilitated.

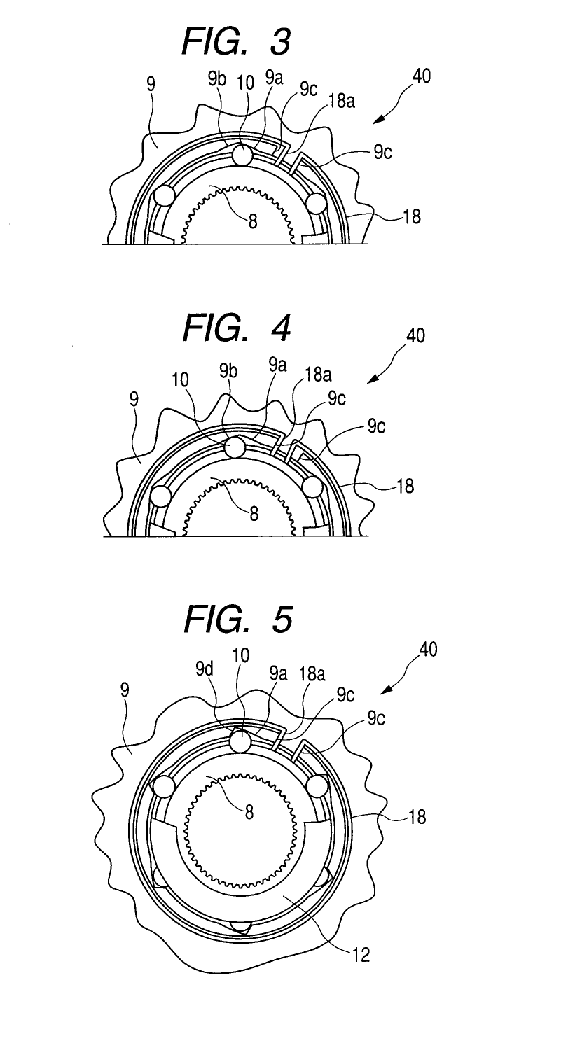

FIG. 2 is a front view, in partial fragmental, of the clutch shown in FIG. 1, showing a condition that the clutch is not locked. Further. FIG. 3 is a front view, in partial fragmental, of the clutch shown in FIG. 1, showing a condition that the clutch is locked in a clockwise direction with respect to the rotation the inner race 8. Further, FIG. 4 is a front view, in partial fragmental, of the clutch shown in FIG. 1, showing a condition that the clutch is locked in an anti-clockwise direction with respect to the rotation the inner race 8.

In FIGS. 2 to 4, a two-way clutch is used as the clutch 40. The clutch 40 has a function capable of locking the rotation in both circumferential directions, and the outer race 9 is provided at its inner peripheral surface with two cam surfaces 9a and 9b having opposite inclinations. Both bent end portions 18a of the C-shaped holder biasing spring 18 are engaged with an end face 9c of the outer race 9 and a notch portion 11a of the holder 11. The holder biasing spring 18 serves to apply a biasing force for holding the roller 10 in a neutral position to the holder 11.

FIG. 2 shows a condition that the rollers 10 are in the neutral position and the clutch is not locked in both rotational directions. FIG. 3 shows a condition that the rollers 10 are engaged with the cam surfaces 9a to lock the clutch in the clockwise direction, and FIG. 4 shows a condition that the rollers 10 are engaged with the cam surfaces 9b to lock the clutch in the anti-clockwise direction.

FIG. 5 is a front view, in partial fragmental, of the clutch shown in FIG. 1, showing a condition that the clutch is locked in a clockwise direction with respect to the rotation the inner race 8. Here, a one-way clutch is used as the clutch 40. The holder friction plate 12, holder biasing spring 18 and holder controlling plate 13 have the same functions as already explained in connection with FIGS. 2 to 4. In FIG. 5, the outer race 9 has cam surfaces 9a in the clockwise direction and wall portions 9d contiguous to the cam surfaces 9a in the anti-clockwise direction.

FIG. 5 shows a condition that the rollers 10 are in the neutral position not to lock the clutch. In this condition, the rollers 10 are contacted with the wall portions 9d and the cam surfaces 9a. From this condition, when the outer race 9 and the inner race 8 are rotated relatively to engage the rollers 10 with the cam surfaces 9a, the clutch 40 is locked.

In the above-mentioned embodiment, while an example that the one-way clutch of roller type is used as the clutch was explained, it should be noted that a one-way clutch of other type such as a clutch of splag type may be used. Further, the friction materials stuck to the internal toothed plates 5 and the external toothed plates 6 may be annular friction materials or may be constituted by plural friction material segments arranged in an annular fashion.

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2006-148282, filed May 29, 2006, which is hereby incorporated by reference herein in its entirety.

What is claimed is:

1. A wet multi-plate clutch of mechanical coupling type in which a friction engaging element and a mechanical coupling element are operated by a single piston, wherein:
said friction engaging element is operated by an urging force of said single piston smaller than a predetermined load, and said friction engaging element and said mechanical coupling element are operated by an urging force of said single piston greater than said predetermined load.

2. A wet multi-plate clutch of mechanical coupling type according to claim 1, wherein said friction engaging element is a wet multi-plate clutch and said mechanical coupling element is a two-way clutch.

3. A wet multi-plate clutch of mechanical coupling type according to claim 1, wherein said friction engaging element is a wet multi-plate clutch and said mechanical coupling element is a one-way clutch.

4. A wet multi-plate clutch of mechanical coupling type according to claim 1, wherein said mechanical coupling element is designed so that a roller is driven in an engaging direction by a friction force between a holder controlling plate and a holder.

5. A wet multi-plate clutch of mechanical coupling type according to claim 1, wherein said predetermined load is set by an urging force of a biasing member disposed between a load controlling plate and a backing plate.
